(19) United States
(12) Patent Application Publication
(10) Pub. No.: US 2016/0016615 A1
(43) Pub. Date: Jan. 21, 2016

(54) HOOD FOR A VEHICLE

(71) Applicant: Audi AG, Ingolstadt (DE)

(72) Inventors: Bernhard-Konrad Pfaller, Denkendorf (DE); Martin Seiler, Hitzhofen (DE); Markus Wittmann, Denkendorf (DE)

(73) Assignee: Audi AG, Ingolstadt (DE)

(21) Appl. No.: 14/801,525

(22) Filed: Jul. 16, 2015

(30) Foreign Application Priority Data
Jul. 17, 2014 (DE) 10 2014 010 633.0

(51) Int. Cl. B62D 25/12

(52) U.S. Cl. CPC B62D 25/12

(57) ABSTRACT

A hood for a vehicle includes an outer part, an inner part and a reinforcement element having at least one area arranged between the outer part and the inner part. The reinforcement element has at least one mount configured in the form of a bracket to connect the reinforcement element with the inner part. A first fastening element is supported by the at least one bracket for attachment of a component.

### CROSS-REFERENCES TO RELATED APPLICATIONS

This application claims the priority of German Patent Application, Serial No. 102014010633.0, filed Jul. 17, 2015, pursuant to 35 U.S.C. 119(a)-(d), the disclosure of which is incorporated herein by reference in its entirety as if fully set forth herein.

### BACKGROUND OF THE INVENTION

The present invention relates to a hood for a vehicle.

The following discussion of related art is provided to assist the reader in understanding the advantages of the invention, and is not to be construed as an admission that this related art is prior art to this invention.

Hoods for vehicles are known to have an outer part and an inner part which is coupled to a reinforcement element, which is arranged between the outer and inner parts in a forward region of the hood. Reference is made, e.g., to applicant's production car Audi A6 with platform AU57x. The reinforcement element is hereby secured from above upon the inner part such that their connecting surfaces abut one another to prevent the presence of an air gap. As a result, a very rigid “pot shape” is created that adversely affects pedestrian protection so that additional deformation parts need to be provided.

It would therefore be desirable and advantageous to provide an improved hood for a vehicle to obviate prior art shortcomings and to provide an effective pedestrian protection.

### SUMMARY OF THE INVENTION

According to one aspect of the present invention, a hood for a vehicle includes an outer part, an inner part, a reinforcement element having at least one area arranged between the outer part and the inner part, the reinforcement element having at least one mount configured in the form of a bracket to connect the reinforcement element with the inner part, and a first fastening element received by the at least one bracket for attachment of a component.

In accordance with the present invention, a hood is realized which enables a stable attachment of components to be mounted and provides effective pedestrian protection, without the need for any additional deformation parts. The provision of a mount in the form of a bracket for the (first) fastening element and thus an attachment of the fastening element via a bracket geometry, results in a very stable construction which is yielding so as to reduce the risk of injury for pedestrians in the event of a collision. The placement of the fastening element for attachment of the component is implemented during construction of the body shell.

A hood according to the present invention is able to realize a substantially greater deformation path so that impact forces on a pedestrian can be significantly reduced. Thus, the protection of pedestrians is greatly enhanced. Additional measures, e.g. provision of sheet metal deformation parts, are not needed. Furthermore, buckling resistance and polishing stiffness are realized in an optimal manner by the provision of the reinforcement element.

According to another advantageous feature of the present invention, the reinforcement element can have at least one opening for arrangement of the at least one bracket. Advantageously, the at least one bracket has an L-shaped configuration having one leg configured as a contact surface. Thus, the at least one bracket can be bent in a direction of the inner part to enable the contact surface to rest upon the inner part.

According to another advantageous feature of the present invention, at least one fixation element can be provided to secure the contact surface upon the inner part. The fastening element is then attached during body shell assembly. Advantageously, the fastening element can be configured as a bolt having a screw thread on one end and a head on another end, with the screw thread being forced through the contact surface and the inner part so that the head rests upon the contact surface and the screw thread projects beyond the inner part. Thus, the component being attached can be secured in a simple manner.

According to another advantageous feature of the present invention, a second fastening element can be provided to interact with the first fastening element for connection of the component to the inner part and/or reinforcement element.

According to another advantageous feature of the present invention, the component may be a structural part of a hood closing device. For example, the component can be a restraining bar or a hood latch.

According to another advantageous feature of the present invention, the second fastening element can be a nut for threaded engagement with the first fastening element to secure a base plate of the component to the inner part and/or reinforcement element.

According to another advantageous feature of the present invention, the reinforcement element can be configured as stamped bent part. This enables a rapid and cost-effective production of the reinforcement element.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective illustration of a detail of an exemplary embodiment of a hood according to the present invention;

FIG. 2 is a schematic top perspective illustration of a forward portion of the hood of FIG. 1, without outer part;

FIG. 3 is an enlarged detailed schematic perspective view of an area encircled in FIG. 1; and

FIG. 4 is a schematic sectional view, taken along the section line IV in FIG. 3.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

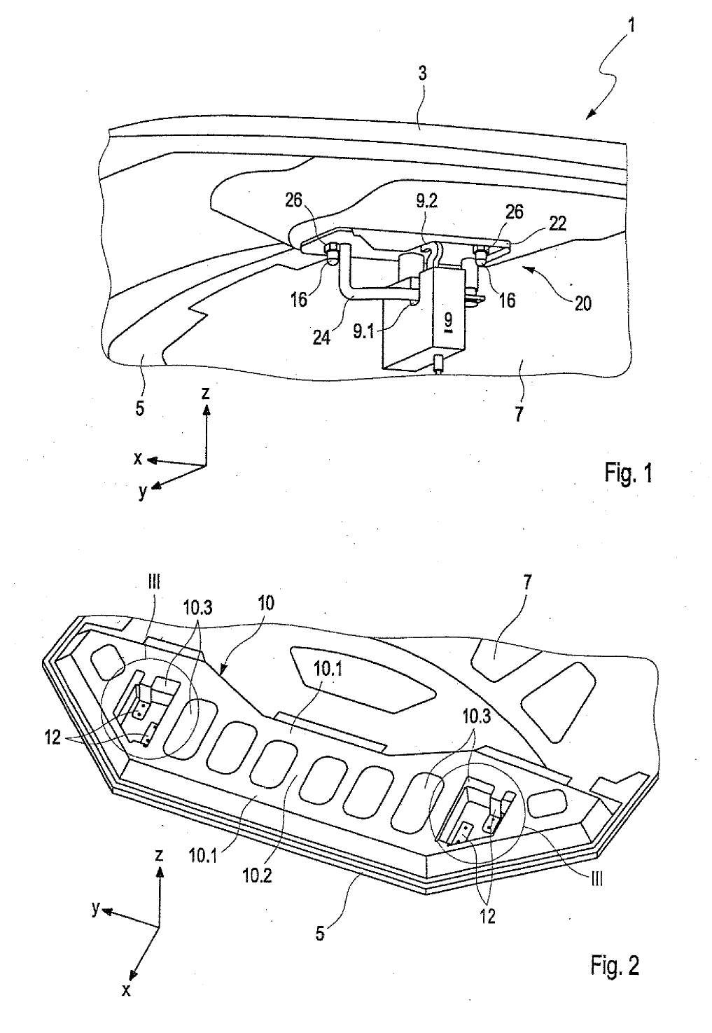

Turning now to the drawing, and in particular to FIG. 1, there is shown a schematic perspective illustration of a detail of an exemplary embodiment of a hood according to the present invention, generally designated by reference numeral 1 and adapted for use in a vehicle. It is to be understood by persons skilled in the art that the term “hood” is used here in a generic sense and the principles described in the following description with respect to the hood are equally applicable to any other type of cover, flap, lid or also hatchback, which generally follows the concepts outlined here. In the non-limiting example of FIG. 1, the hood 1 is configured as an engine hood.

The hood 1 includes an outer part 3 and at least one inner part 5 which is coupled to a reinforcement element 10, shown in greater detail in FIG. 2. The reinforcement element 10 has at least one area arranged between the outer part 3 and the inner part 5, and includes at least one mount for receiving at least one first fastening element 16 for attachment of a component 20. The mount is configured in accordance with the present invention in the form of a bracket 12 by which the reinforcement element 10 is connected with the inner part 5 and which receives the fastening element 16.

The hood 1 includes a lining 7 which faces the engine compartment, or trunk space in the event the hood is a hatchback, that is to be covered. The lining 7 is made advantageously of insulating material for noise suppression.

For sake of simplicity and ease of illustration of important aspects of the invention, FIGS. 2 to 4 do not show the outer part 3 which, advantageously, is configured as an outer skin.

As is readily apparent from FIG. 2, the reinforcement element 10 is configured as stamp bent part and includes two longitudinal webs 10.1, which substantially extend in vehicle transverse direction y, and several transverse webs 10.2, which substantially extend in vehicle longitudinal direction x. The longitudinal webs 10.1 and the transverse webs 10.2 bound several openings 10.3, formed in the reinforcement element 10. As is further shown in FIG. 2, two of the openings 10.3 receive each two brackets 12. The brackets 12 are angle brackets and have an L-shaped configuration. Each of the brackets 12 has a leg to form a contact surface 14. The brackets 12 are shaped through bending in each of the two openings 10.3 in a direction toward the inner part 5 so that the contact surfaces 14 of the brackets 12 rest against the inner part 5. The other ends of the brackets 12 are each connected with or formed on one of the longitudinal webs 10.1. In addition, the two brackets 12 in each of the two openings 10.3 are arranged in offset relationship so that the brackets 12 are arranged at different longitudinal webs 10.1.

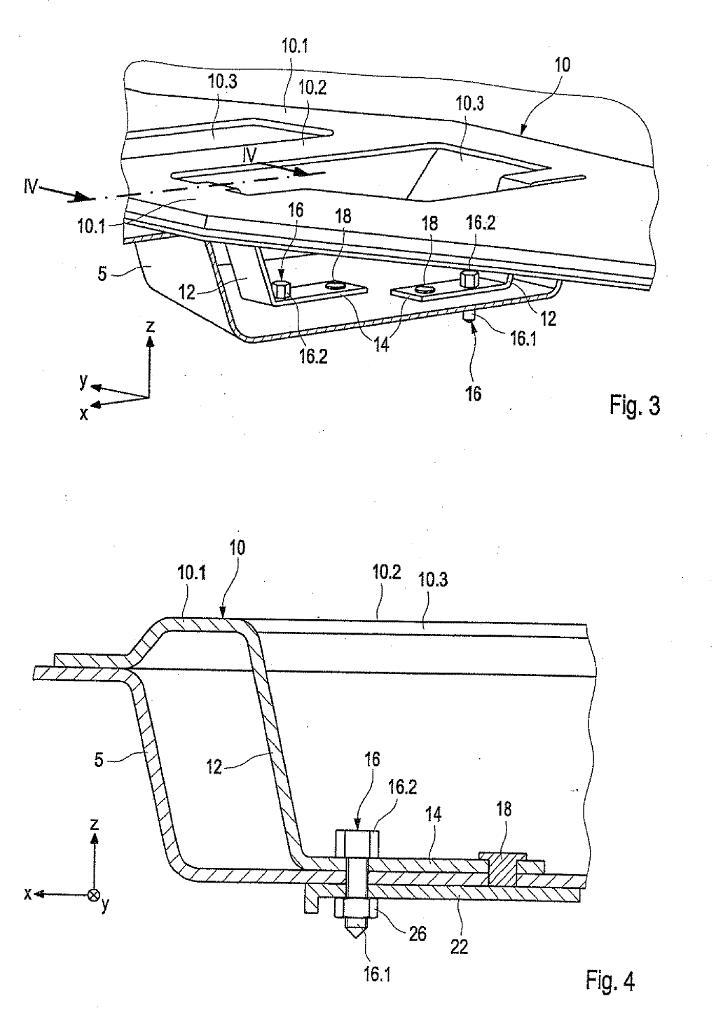

Referring now to FIG. 3, there is shown an enlarged detailed schematic perspective view of an area encircled in FIG. 1, and it can be seen that the contact surfaces 14 of the brackets 12 are secured by at least one fixation element 18 to the inner part 5. The fixation element 18 can, advantageously, be configured as a clinch connection. As shown in particular in FIG. 4, which is a schematic sectional view, taken along the section line IV in FIG. 3, the fastening element 16 in each bracket 12 is configured as a threaded bolt having a screw thread 16.1 on one end and a head 16.2 on another end. The screw thread 16.1 traverses the contact surface 14 and the inner part 5 so that the head 16.2 bears upon the contact surface 14 and the screw thread 16.1 extends out beyond the inner part 5. Interacting with the first fastening element 16 is a second fastening element 26 to fasten the component 20 to the inner part 5 and/or the reinforcement element 10. The component 20 to be attached may, for example, be a component of a hood closing device.

In the non-limiting example described herein, the hood closing device has two components 20 to be fastened to the hood 1, which have each a retaining bar 24 (cf. FIG. 1). One of the components 20 of the hood closing device is arranged in the left-hand forward region of the hood 1 and the other one of the components 20 of the hood closing device is arranged in the right-hand forward region of the hood 1. In the closed state, the retaining bars 24 of the components 20 are locked in receptacles 9.1, respectively, of a body-side hood latch 9 which is shown schematically in FIG. 1 and arranged on a body element, not shown, of the vehicle. Although not shown in FIG. 1, two such hood latches 9 are arranged on the vehicle body and respectively cooperating with the retaining bars 24. When the hood 1 is raised, the retaining bars 24 are embraced by catch hooks 9.2, respectively, of the corresponding hood latches 9. The hood 1 is opened by unhooking the catch hooks 9.2 of the hood latches 9 to liberate the retaining bars 24. As an alternative, the hood latches 9 with the receptacles 9.1 and the catch hooks 9.2 may also be arranged on the hood 1 whereas the retaining bars 24 are arranged in the vehicle body. Of course, the first fastening elements 16 may also be used for fastening other vehicle components, such as, e.g. lighting elements etc.

As is further readily apparent from FIGS. 1 and 4, the component 20 includes a base plate 22 which is threadably engaged to the inner part 5 and/or the reinforcement element 10 by the second fastening element 26, configured here as a nut and threadably engaged with the screw thread 16.1. The brackets 12 in the corresponding openings 10.3 receive each a fastening element 16. In the event, a component to be fastened requires the presence of more than two attachment points, more than two brackets 12 can be arranged in the corresponding openings 10.3. Moreover, the brackets 12 may also receive more than one of the first fastening elements 16.

As a result of the attachment of at least one fastening element 16 via a bracket geometry, a hood for a vehicle in accordance with the present invention becomes very stable and yet is sufficiently yielding for pedestrian protection. Thus, the deformation path is substantially greater so that impact force a pedestrian is exposed to considerably reduced impact forces.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A hood for a vehicle, comprising:
an outer part;
an inner part;
a reinforcement element having at least one area arranged between the outer part and the inner part, said reinforcement element having at least one mount configured in the form of a bracket to connect the reinforcement element with the inner part; and
a first fastening element received by the at least one bracket for attachment of a component.

2. The hood of claim 1, wherein the reinforcement element has at least one opening for arrangement of the at least one bracket.

3. The hood of claim 1, wherein the at least one bracket has an L-shaped configuration having one leg configured as a contact surface.

4. The hood of claim 3, wherein the at least one bracket is bent in a direction of the inner part to enable the contact surface to rest upon the inner part.

5. The hood of claim 4, further comprising at least one fixation element to secure the contact surface upon the inner part.

6. The hood of claim 4, wherein the first fastening element is configured as a bolt having a screw thread on one end and a head on another end, said screw thread traversing the contact surface and the inner part so that the head rests upon the contact surface and the screw thread projects beyond the inner part.

7. The hood of claim 1, further comprising a second fastening element interacting with the first fastening element for connection of the component to the inner part and/or reinforcement element.

8. The hood of claim 1, wherein the component is a structural part of a hood closing device.

9. The hood of claim 7, wherein the second fastening element is a nut for threaded engagement to the first fastening element to secure a base plate of the component to the inner part and/or reinforcement element.

10. The hood of claim 1, wherein the reinforcement element is configured as stamped bent part.

11. The hood of claim 1, wherein the reinforcement element has at least one opening for arrangement of at least two of said bracket placed in offset relationship.
